(19) United States
(12) Patent Application Publication
(10) Pub. No.: US 2015/0191593 A1
(43) Pub. Date: Jul. 9, 2015

(54) FLAME-RETARDANT POLYMER COMPOSITIONS AND MOLDED ARTICLES COMPRISING THE SAME

(71) Applicant: E.I. DU PONT DE NEMOURS AND COMPANY, Wilmington, DE (US)

(72) Inventors: Cheng Wang, Shanghai (CN); Guangiun Hu, Shanghai (CN); Ming Fang, Shanghai (CN)

(21) Appl. No.: 14/413,358

(22) PCT Filed: Jul. 8, 2013
(86) PCT No.: PCT/US2013/049510

§ 371 Date: Jan. 7, 2015

(30) Foreign Application Priority Data
Jul. 11, 2012 (CN) 201210240409.1

(51) Int. Cl. C08L 67/02; C08K 5/52; C08K 5/5313

(52) U.S. Cl. CPC C08L 67/02; C08K 5/5313; C08K 5/52

(57) ABSTRACT

Disclosed herein is a flame-retardant polymer composition including, (a) at least one thermoplastic polymer; (b) about 5-35 wt % of at least one phosphorus-based halogen-free flame retardant; (c) about 0.1-50 wt % of at least one melamine-formaldehyde coated nitrogen-containing compound; and optionally (d) up to about 70 wt % of at least one reinforcing filler, with the total wt % of all components included in the flame-retardant polymer composition totaling to 100 wt %, wherein the at least one melamine-formaldehyde coated nitrogen-containing compound includes a core that is coated with a coating material with the core formed of at least one nitrogen-containing compound and the coating material formed of melamine formaldehyde.

### TECHNICAL FIELD

The disclosure is related to flame-retardant polymer compositions and molded articles comprising the same.

### BACKGROUND

Various flame retardant systems have been developed and used in polymeric material, e.g., polyesters, to improve the flame-retardant property thereof. However, due to toxicity concerns, halogen-free flame retardants are gaining more and more attention. Among the different halogen-free flame retardants, phosphorus compounds (such as salts of phosphinic or diphosphinic acids) are used the most due to the stability and flame retardant effectiveness thereof. Prior art has also demonstrated that numerous types of synergistic compounds can be used as synergists in combination with the phosphorus compounds to further maximize their flame retardant effectiveness. And nitrogen-containing compounds have been disclosed as one of the more common flame retardant synergists for phosphorus compounds type of flame retardants. For example, U.S. Pat. No. 6,365,071 has disclosed the use of nitrogen-containing compounds (e.g., melamine cyanurate, melamine phosphate, melamine pyrophosphate, or melamine diborate) as flame retardant synergists and U.S. Pat. No. 6,255,371 has disclosed the use of reaction products of phosphoric acids with melamine or condensation product of melamine (e.g., melamine polyphosphate (MPP)) as flame retardant synergists. In addition, European Patent Publication No. EP1883081 and PCT Patent Publication Nos. WO2009/047353 and WO2010/094560 have disclosed the use of combinations of (i) a metal salt of a phosphinic acid and/or a diphosphinic add, (ii) a nitrogen-containing compound (e.g., melamine polyphosphate), and (iii) an inorganic compound (e.g., zinc borate) as preferred flame retardant packages. Korean Patent No. KR 2010038701 also has disclosed a flame retardant package useful in copolyetherester compositions, which comprised an organic phosphinate metal salt, a melamine cyanurate, and an aromatic phosphate.

Prior arts also have suggested the use of nitrogen-containing compounds (such as MPP) alone as flame retardants in polymeric materials. For example, U.S. Pat. No. 6,015,510 and China Patent Application Publication Nos. CN102229712 and CN102174247 have disclosed that coated MPP (such as MPP coated with organosilane, ester, polyol, dianhydride, dicarboxylic acid, melamine-formaldehyde (MF), silica, or mixtures thereof) can be used as flame retardants in polymeric materials and that the coated MPP has improved dispersability in polymer matrix compared to non-coated MPP.

However, as presented herebelow, when nitrogen-containing compounds (such as MPP) are used as synergists in addition to phosphorus-based flame retardants (such as metal salt of (di)phosphinic acid), there are often precipitates left on the surface of the molds during injection molding process, which is called mold deposits. Such mold deposits cause a reduction on molding efficiency. Moreover, the surface appearance, gloss, and other related performances of the molded article also could be negatively affected by the mold deposits. Thus, there is still a need to develop a phosphorus-based flame-retardant system that is free of mold deposit during injection molding processes.

### SUMMARY

Provided herein is a flame-retardant polymer composition that comprises, (a) at least one thermoplastic polymer; (b) 5-35 wt % of at least one phosphorus-based halogen-free flame retardant; (c) 0.1-50 wt % of at least one melamine-formaldehyde coated nitrogen-containing compound; and optionally (d) up to 70 wt % of at least one reinforcing filler, with the total wt % of all components comprised in the flame-retardant polymer composition totaling to 100 wt %, and wherein the at least one melamine-formaldehyde coated nitrogen-containing compound comprises a core that is coated with a coating material with the core formed of at least one nitrogen-containing compound and the coating material formed of melamine formaldehyde.

In one embodiment of the flame-retardant polymer composition, the at least one thermoplastic polymer is selected from the group consisting of thermoplastic polyesters, polyamides, polyoxymethylenes, polycarbonates, polyolefins, polyphenylene oxides, polyimides, and combinations of two or more thereof; or, the at least one thermoplastic polymer is selected from the group consisting of thermoplastic polyesters, polyamides, and combinations thereof; or, the at least one thermoplastic polymer is selected from thermoplastic polyesters.

In a further embodiment of the flame-retardant polymer composition, the at least one thermoplastic polymer is present in the flame-retardant polymer composition at a level of 20-70 wt % or 30-60 wt %, based on the total weight of the composition.

In a yet further embodiment of the flame-retardant polymer composition, the at least one phosphorus-based halogen-free flame retardant is selected from the group consisting of phosphinates of the formula (I), disphosphinates of the formula (II), and combinations or polymers thereof

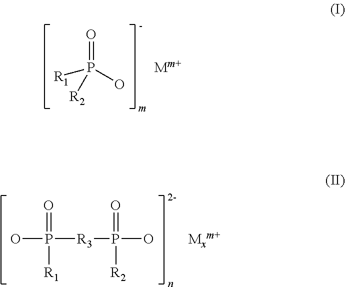

with R₁ and R₂ being identical or different and each of R₁ and R₂ being hydrogen, a linear, branched, or cyclic C₁-C₆ alkyl group, or a C₆-C₁₀ aryl; R₃ being a linear or branched C₁-C₁₀ alkylene group, a C₆-C₁₀ arylene group, a C₆-C₁₂ alkyl-arylene group, or a C₆-C₁₂ aryl-alkylene group; M being selected from the group consisting of calcium ions, aluminum ions, magnesium ions, zinc ions, antimony ions, tin ions, germanium ions, titanium ions, iron ions, zirconium ions, cerium ions, bismuth ions, strontium ions, manganese ions, lithium ions, sodium ions, potassium ions and combinations thereof; and m, n, and x each being a same or different integer of 1-4.

In a yet further embodiment of the flame-retardant polymer composition, the at least one phosphorus-based halogen-free flame retardant is selected from the group consisting of aluminum methylethylphosphinate, aluminum diethylphosphinate, aluminum hypophosphite, and combinations or two or more thereof, or the at least one phosphorus-based halogen-free flame retardant is aluminum methylethylphosphinate or aluminum diethylphosphinate.

In a yet further embodiment of the flame-retardant polymer composition, the at least one phosphorus-based halogen-free flame retardant is present in the flame-retardant polymer composition at a level of 7.5-30 wt %, based on the total weight of the composition.

In a yet further embodiment of the flame-retardant polymer composition, the at least one nitrogen-containing compound is selected from the group consisting of (i) melamine cyanurate, (ii) condensation products of melamine, (iii) reaction products of phosphoric acid with melamine, and (iv) reaction products of phosphoric acid with condensation products of melamine, or the at least one nitrogen-containing compound is melamine polyphosphate.

In a yet further embodiment of the flame-retardant polymer composition, the at least one melamine-formaldehyde coated nitrogen-containing compound comprises about 5-60 wt % or about 10-45 wt % of the coating material, based on the total weight of the melamine-formaldehyde coated nitrogen-containing compound.

In a yet further embodiment of the flame-retardant polymer composition, the melamine-formaldehyde coated nitrogen-containing compound is present in the flame-retardant polymer composition at a level of 1-30 wt % or 2-15 wt %, based on the total weight of the composition.

In a yet further embodiment of the flame-retardant polymer composition, the at least one reinforcing filler is selected from fibrous inorganic materials, inorganic fillers, organic fillers, and combinations of two or more thereof, or the at least one reinforcing filler is selected from glass fibers.

In a yet further embodiment of the flame-retardant polymer composition, wherein the at least one reinforcing filler is present in the flame-retardant polymer composition at a level of 5-50 wt %, based on the total weight of the composition.

Further provided herein is a molded article formed of the flame-retardant polymer composition described above. Preferably, the molded article is formed by injection molding.

In accordance with the present disclosure, when a range is given with two particular end points, it is understood that the range includes any value that is within the two particular end points and any value that is equal to or about equal to any of the two end points.

### DESCRIPTION

Disclosed herein is a flame-retardant polymer composition comprising, (a) at least one thermoplastic polymer; (b) about 5-35 wt % of at least one phosphorus-based halogen-free flame retardant; (c) about 0.1-50 wt % of at least one melamine-formaldehyde (MF) coated nitrogen-containing compound; and optionally (d) up to about 70 wt % of at least one reinforcing filler, with the wt % of all components comprised in the composition totaling to 100 wt %.

The term “thermoplastic polymer” is used herein referring to polymers that turn to a liquid when heated and freeze to a rigid state when cooled sufficiently. In accordance with the present disclosure, the thermoplastic polymers used herein also include thermoplastic elastomers. In a preferred embodiment, the thermoplastic polymers used herein are those having a melting point of about 150-330° C. For such thermoplastic polymers having high melting point, when they are to be made into molded articles, the barrel temperature of the injection molding machine need to be set at above the melting point of the polymer resin. Preferably the barrel temperature needs to be set at about 10° C. or more above the melting point of the polymer resin. Or, the barrel temperature may be in the range of about 200-350° C. The thermoplastic polymers used herein may include, without limitation, thermoplastic polyesters, polyamides, polyoxymethylenes, polycarbonates, polyolefins, polyphenylene oxides, polyimides, and combinations of two or more thereof.

In accordance with the present disclosure, suitable thermoplastic polyesters include, without limitation, polyethylene terephthalate (PET), polybutylene terephthalate (PBT), polytrimethylene terephthalate (PTT), polycyclohexylene dimethylene terephthalate (PCT), polyester elastomers (such as copolyetherester). The thermoplastic polyesters used herein may also be obtained commercially from various vendors. For example, suitable PET may be obtained commercially from E.I. du Pont de Nemours and Company (U.S.A.) (hereafter “DuPont”) under the trade name Rynite®; suitable PBT may be obtained commercially from DuPont under the trade name Crastin®; suitable PTT may be obtained commercially from DuPont under the trade name Sorona®; suitable POT may be obtained commercially from Ticona, The Netherland under the trade name Thermx™; and suitable copolyetheresters may be obtained commercially from DuPont under the trade name Hytrel®.

In accordance with the present disclosure, suitable polyamides include both aliphatic polyamides and aromatic polyamides.

Polyamides are (a) condensation products of one or more dicarboxylic acids and one or more diamines, or (b) condensation products of one or more aminocarboxylic acids, or (c) ring opening polymerization products of one or more cyclic lactams. The aromatic polyamides used herein may be homopolymers, copolymers, terpolymers or higher polymers containing at least one aromatic monomer component. For example, an aromatic polyamide may be obtained by using an aliphatic dicarboxylic acid and an aromatic diamine, or an aromatic dicarboxylic acid and an aliphatic diamine as starting materials and subjecting them to polycondensation.

Suitable diamines used herein may be selected from aliphatic diamines, alicyclic diamines, and aromatic diamines. Exemplary diamines useful herein include, without limitation, tetramethylenediamine; hexamethylenediamine; 2-methylpentamethylenediamine; nonamethylenediamine; undecamethylenediamine, dodeca-methylenediamine; 2,2,4-trimethylhexamethylenediamine; 2,4,4 trimethylhexamethylenediamine; 5-methylnonamethylene-diamine; 1,3-bis(aminomethyl)cyclohexane; 1,4-bis(aminomethyl)cyclohexane; 1-amino-3 aminomethyl-3,5,5-trimethylcyclohexane; bis(4-aminocyclohexyl)methane; bis(3-methyl-4-aminocyclohexyl)methane; 2,2-bis(4-aminocyclohexyl)propane; bis(aminopropyl)piperazine; aminoethylpiperazine; bis(p-aminocyclohexyl)methane; 2-methyloctamethylenediamine; trimethylhexamethylenediamine, 1,8-diaminooctane; 1,9 diaminononane; 1,10-diaminodecane; 1,12-diaminododecane; m-xylylenediamine; p-xylylenediamine; and the like and derivatives thereof.

Suitable dicarboxylic acids used herein may be selected from aliphatic dicarboxylic acids, alicyclic dicarboxylic acids, and aromatic dicarboxylic acids. Exemplary dicarboxylic acids useful herein include, without limitation, adipic acid; sebacic acid; azelaic acid; dodecanedoic acid; terephthalic acid; isophthalic acid; phthalic acid; glutaric acid; pimelic acid; suberic acid; 1,4-cyclohexanedicarboxylic acid; naphthalenedicarboxylic acid; and the like and the like and derivatives thereof.

Exemplary aliphatic polyamides used herein include, without limitation, polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; polyamide 6,13; and the like.

Exemplary aromatic polyamides used herein include, without limitation, poly(m-xylylene adipamide) (polyamide MXD,6); poly(dodecamethylene terephthalamide) (polyamide 12,T); poly(hendecamethylene terephthalamide) (polyamide 11,T); poly(decamethylene terephthalamide) (polyamide 10,T); poly(nonamethylene terephthalamide) (polyamide 9,T); poly(hexamethylene terephthalamide) (polyamide 6,T); hexamethylene adipamide/hexamethylene terephthalamide copolyamide (polyamide 6,T/6,6, i.e., polyamide 6,T/6,6 having at least about 50 mol % of its repeating units derived from 6,T); hexamethylene terephthalamide/hexamethylene adipamide copolyamide (polyamide 6,6/6,T, i.e., polyamide 6,6/6,T having at least about 50 mol % of its repeating units derived from 6,6); poly(hexamethylene terephthalamide/hexamethylene isophthalamide) (polyamide 6,T/6,I, i.e., polyamide 6,T/6I having at least about 50 mol % of its repeating units derived from 6,T); hexamethylene terephthalamide/2-methylpentamethylene terephthalamide copolyamide (polyamide 6,T/D,T); hexamethylene adipamide/hexamethylene terephthalamide/hexamethylene isophthalamide copolyamide (polyamide 6,6/6,T/6,I); poly(caprolactam-hexamethylene terephthalamide) (polyamide 6/6,T); poly(hexamethylene isophthalamide/hexamethylene terephthalamide) (polyamide 6,I/6,T, i.e., polyamide 6,I/6,T having at least about 50 mol % of its repeating units derived from 6,I); poly(hexamethylene isophthalamide) (polyamide 6,I); poly(metaxylylene isophthalamide/hexamethylene isophthalamide) (polyamide MXD,I/6,I); poly(metaxylylene isophthalamide/metaxylylene terephthalamide/hexamethylene isophthalamide) (polyamide MXD,I/MXD,T/6,I/6,T); poly(metaxylylene isophthalamide/dodecamethylene isophthalamide) (polyamide MXD,I/12,I); poly(metaxylylene isophthalamide) (polyamide MXD,I); poly(dimethyldiaminodicyclohexylmethane isophthalamide/dodecanamide) (polyamide MACM,I/12); poly(dimethyldiaminodicyclohexylmethane isophthalamide/dimethyldiaminodicyclohexylmethane terephthalamide/dodecanamide) (polyamide MACM,I/MACM,T/12), poly(hexamethylene isophthalamide/dimethyldiaminodicyclohexylmethane isophthalamide/dodecanamide) (polyamide 6,I/MACM,I/12), poly(hexamethylene isophthalamide/hexamethylene terephthalamide/dimethyldiaminodicyclohexylmethane isophthalamid/dimethyldiaminodicyclohexylmethane terephthalamide) (polyamide 6,I/6,T/MACM,I/MACM,T); poly(hexamethylene isophthalamide/hexamethylene terephthalamide/dimethyldiaminodicyclohexylmethane isophthalamid/dimethyldiaminodicyclohexylmethane terephthalamide/dodecanamide) (polyamide 6,I/6,T/MACM,I/MACM,T12); poly(dimethyldiaminodicyclohexylmethane isophthalamide/dimethyldiaminodicyclohexylmethane dodecanamide) (polyamide MACM,I/MACM,12); and the like.

Based on the total weight of the flame-retardant polymer composition disclosed herein, the at least one thermoplastic polymer may be present at a level of about 20-70 wt % or about 30-60 wt %.

The phosphorus-based halogen-free flame retardants suitable for use in the compositions disclosed herein may be selected from phosphinates of the formula (I), disphosphinates of the formula (II), and combinations or polymers thereof

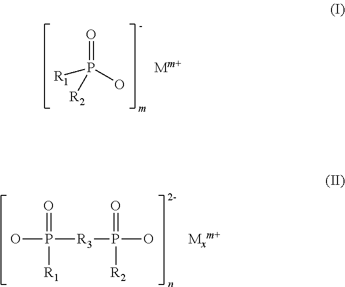

wherein R₁ and R₂ may be identical or different and each of R₁ and R₂ is hydrogen, a linear, branched, or cyclic C₁-C₆ alkyl group, or a C₆-C₁₃ aryl group; R₃ is a linear or branched C₁-C₁₀ alkylene group, a C₆-C₁₀ arylene group, a C₆-C₁₂ alkyl-arylene group, or a C₆-C₁₂ aryl-alkylene group; M is selected from calcium ions, aluminum ions, magnesium ions, zinc ions, antimony ions, tin ions, germanium ions, titanium ions, iron ions, zirconium ions, cerium ions, bismuth ions, strontium ions, manganese ions, lithium ions, sodium ions, potassium ions, and combinations thereof; each of m, n, and x is a same or different integer of 1-4. Preferably, R₁ and R₂ may be independently selected from hydrogen, methyl, ethyl, n-propyl, isopropyl, n-butyl, tert-butyl, n-pentyl, and phenyl; R₃ may be selected from methylene, ethylene, n-propylene, isopropylene, n-butylene, tertbutylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene, and phenylbutylene; and M may be selected from aluminum and zinc ions. More preferably, the phosphinates used here is selected from aluminum hypophosphite, aluminum methylethylphosphinate, aluminum diethylphosphinate, and combinations thereof. Yet more preferably, the phosphinates used here is selected from aluminum methylethylphosphinate, aluminum diethylphosphinate, and combinations thereof.

The halogen-free flame retardants useful herein may also be obtained commercially from Clariant (Switzerland) under the trade name Exolit™ OP. In a yet further embodiment, the halogen-free flame retardant used herein is an aluminum hypophosphite, which may be obtained commercially from Italmatch Chemicals (Italy) under the trade name Phoslite™ IP-A.

Based on the total weight of the flame-retardant polymer composition disclosed herein, the at least one phosphorus-based halogen-free flame retardant may be present at a level of about 5-35 wt % or about 7.5-30 wt %.

Within the flame-retardant polymer composition disclosed herein, in addition to the phosphorus-based halogen-free flame retardant, at least one MF coated nitrogen-containing compound is also incorporated as flame retardant synergist. The MF coated nitrogen-containing compound used herein comprises a core that is coated with a coating material, wherein the core comprises or is formed of a nitrogen-containing compound and the coating material comprises or is formed of MF.

The nitrogen-containing compounds used herein may include, without limitation, those described, for example in U.S. Pat. Nos. 6,365,071; and 7,255,814. In one embodiment, the nitrogen-containing compounds used herein are selected from melamine, benzoguanamine, tris(hydroxyethyl)isocyanurate, allantoine, glycoluril, dicyandiamide, guanidine, carbodiimide, and derivatives thereof. In a further embodiment, the nitrogen-containing compounds used herein may be selected from melamine derivatives, which include, without limitation, (i) melamine cyanurate, (ii) condensation products of melamine, (iii) reaction products of phosphoric acid with melamine, and (iv) reaction products of phosphoric acid with condensation products of melamine. Suitable condensation products may include, without limitation, melem, melam, melon, as well as higher derivatives and mixtures thereof. Condensation products of melamine can be produced by any suitable methods (e.g., those described in PCT Patent Publication No. WO9616948). Reaction products of phosphoric acid with melamine or reaction products of phosphoric acid with condensation products of melamine are herein understood compounds, which result from the reaction of melamine with a phosphoric acid or the reaction of a condensation product of melamine (e.g., melem, melam, or melon) with a phosphoric acid. Examples include, without limitation, dimelaminephosphate, dimelamine pyrophosphate, melamine phosphate, melamine polyphosphate, melamine pyrophosphate, melamine polyphosphate, melam polyphosphate, melon polyphosphate, and melem polyphosphate, as are described, e.g., in PCT Patent Publication No. WO9839306. In a yet further embodiment, the at least one nitrogen-containing compound used herein is selected from melamine polyphosphate and melamine cyanurate. In a yet further embodiment, the at least one nitrogen-containing compound used herein is melamine polyphosphate.

The MF coated nitrogen-containing compound may be prepared by any suitable process, such as those disclosed in U.S. Pat. Nos. 5,998,503 and 6,015,510 or China Patent Application Publication No. CN102229712. For example, the MF coated nitrogen-containing compound (e.g., MF coated MPP) may be prepared by dispersing MPP in a solution of melamine and formaldehyde followed by mixing and drying.

In accordance with the present disclosure, the MF coated nitrogen-containing compound may comprise about 5-60 wt %, or about 10-45 wt % of MF as the coating material, based on the total weight of the coated compound.

Based on the total weight of the flame-retardant polymer composition disclosed herein, the at least one MF coated nitrogen-containing compound may be present at a level of about 0.1-50 wt %, or about 1-30 wt %, or about 2-15 wt %.

Suitable reinforcing fillers may be selected from fibrous inorganic materials (such as glass fibers, carbon fibers, and whiskers of wollastonite and potassium titanate), inorganic fillers (such as various montmorillonite, talc, mica, calcium carbonate, silica, clay, kaolin, glass powder, and glass beads), organic fillers (such as various organic or polymeric powders), and mixtures of two or more thereof. In one embodiment of the flame-retardant polymer composition disclosed herein, the at least one reinforcing fillers used herein are glass fibers.

Based on the total weight of the flame-retardant polymer composition disclosed herein, the at least one reinforcing filler may be present at a level of up to about 70 wt %, or about 5-50 wt %.

The flame-retardant polymer composition disclosed herein may further comprise other additives, such as colorants, antioxidants, UV stabilizers, UV absorbers, heat stabilizers, lubricants, tougheners, impact modifiers, viscosity modifiers, nucleating agents, plasticizers, mold release agents, scratch and mar modifiers, impact modifiers, emulsifiers, pigments, optical brighteners, antistatic agents, and combinations of two or more thereof. Based on the total weigh of the flame-retardant polymer composition disclosed herein, such additional additive(s) may be present at a level of about 0.01-20 wt % or about 0.01-10 wt %, or about 0.2-5 wt %, or about 0.5-2 wt %.

The flame-retardant polymer composition disclosed herein are melt-mixed blends, wherein all of the polymeric components are well-dispersed within each other and all of the non-polymeric ingredients are homogeneously dispersed in and bound by the polymer matrix, such that the blend forms a unified whole, Any melt-mixing method may be used to combine the polymeric components and non-polymeric ingredients of the composition disclosed herein.

As demonstrated by the examples below, when nitrogen-containing compounds (e.g., MPP) are used in combination with phosphorus-based halogen-free flame retardant (e.g., (di)phosphinate), visible mold deposit is often left on the molding machinery, especially when the barrel temperature is set at high temperatures (such as 200-350° C.). However, when MF-coated MPP is used, no or very little mold deposit is left on the molding machinery.

Further disclosed herein are articles comprising or made of the flame-retardant polymer composition. Preferably, the article is a molded article comprising or made of the flame-retardant polymer composition. The articles may find use in motorized vehicles, electrical/electronic devices, furniture, footwear, building structures, outdoor apparels, water management systems, etc.

### EXAMPLES

### Material

PBT: Polybutylene terephthalate (PBT) resin purchased from Chang Chun Plastics Co. Ltd. (Taiwan);
AO: Pentaerythritol
Tetrakis(3-(3,5-di-tert-butyl-4-hydroxyphenyl)propionate), a phenolic primary antioxidant purchased BASF (Germany) under the trade name of IRGANOX™ 1010;
PTS: pentaerythritol tetrastearate, a lubricant purchased from TCI America (U.S.A.);
GF: glass fiber purchased from Nippon Electric Glass Co. Ltd (Japan) under the trade name NDG 187H;
NHFR: an aluminum diethylphosphinate-based non-halogen flame retardant purchased from Clariant International Ltd. (Switzerland) under the trade name Exolit™ OP1230;
MPP: melamine polyphosphate purchased from BASF under the trade name Melapur™ 200/70;
MF-C-MPP-1: a melamine-formaldehyde coated MPP that was prepared as follows: (a) mixing 30 g melamine and 537 ml formaldehyde solution (37 wt % formaldehyde in a solvent mixture of H₂O and methanol) and 120 ml distilled water in a three-neck bottle with stirring; (b) adjusting the mixture to pH 8-9 with 10% Na₂CO₃ solution; (c) heating the mixture to about 80° C. and maintaining the mixture at about 80° C. for about 1 hour to obtain a melamine-formaldehyde. solution; (d) dispersing 200 g of MPP in the melamine-formaldehyde solution and adjusting the dispersion to pH 4-5 with sulfuric acid; (e) heating the dispersion to about 80° C. and maintaining the dispersion at about 80° C. till the viscosity thereof started to increase (or for about 15 min); (f) drying the dispersion at about 90° C. overnight; (g) washing the dried powder obtained from step (f) with water till the water collected post washing had a pH of at least 5; and (h) drying the washed powder at about 70° C. for overnight (or about 12 hours) to obtain the coated MPP;
MF-C-MPP-2: a melamine-formaldehyde coated MPP that was prepared as follows: (a) mixing 60 g melamine and 107.4 ml formaldehyde solution (37 wt % formaldehyde in a solvent mixture of H₂O and methanol) and 120 ml of distilled water in a three-neck bottle with stirring; (b) adjusting the mixture to pH 8-9 with 10% Na₂CO₃ solution; (c) heating the mixture to about 80° C. and maintaining the mixture at about 80° C. for about 1 hour to obtain a melamine-formaldehyde solution; (d) dispersing 200 g of MPP in the melamine-formaldehyde solution and adjusting the dispersion to pH 4-5 with sulfuric acid; (e) heating the dispersion to about 80° C. and maintaining the dispersion at about 80° C. till the viscosity thereof started to increase (or for about 15 min); (f) drying the dispersion at about 90° C. overnight; (g) washing the dried powder obtained from step (f) with water till the water collected post washing had a pH of at least 5; and (h) drying the washed powder at about 70° C. for overnight (or about 12 hours) to obtain the coated MPP;
SiO₂—C-MPP: a SiO₂ coated MPP that was prepared as follows: (a) dispersing 200 g of MPP into 400 ml of a solvent mixture of ethanol/water (10/1) and adjusting the pH of the dispersion to 8-12; (b) heating the mixture to about 90° C. and agitating the mixture at 90° C. for about 30 min; (c) adding 130 g ethyl silicate (in drops) into the dispersion and letting the mixture react at 90° C. for about 2-4 hours; (d) cooling the mixture to room temperature; (e) filtering the coated MPP powder through a Büchner funnel; (f) washing the powder obtained from step (e) with water till the water collected post washing had a pH of at least 5; and (g) drying the washed powder at about 70° C. for overnight (or about 12 h) to obtain the coated MPP.
UF-C-MPP: a urea-resorcinol-formaldehyde resin coated MPP that was prepared as follows: (a) mixing 4.08 g urea, 20.24 g resorcinol, 150 ml formaldehyde solution (37 wt % formaldehyde in a solvent mixture of H₂O and methanol), 8 g hexamethylene tetramine, and 150 ml water in a glass reaction vessel that was equipped with a reflux cooler and agitator; (b) dispersing 200 g of MPP into the mixture with agitation; (c) adding sulphuric acid into the dispersion with agitation to adjust pH thereof to 1.5; (d) heating the dispersion to 100° C. and maintaining the mixture at 100° C. for 2 hours; (e) cooling the dispersion to room temperature; (f) filtering the coated MPP powder through a Büchner funnel; (g) washing the powder obtained from step (f) with water till the water collected post washing had a pH of at least 5; and (h) drying the washed powder at about 70° C. for overnight (or about 12 h) to obtain the coated MPP.

### Comparative Examples CE1-CE6 and Examples E1-E4

In each of Comparative Examples CE1-CE6 and Examples E1-E4, a composition (all components comprised in each composition are listed in Table 1) was prepared by melt compounding using a ZSK26 twin-screw extruder (purchased from Coperion Werner & Pfleiderer GmbH & Co. (Germany)) with a melting temperature set at 250° C., screw speed at 300 rpm, and throughput at 20 kg/hour.

Further, following ISO 527-1/2 standard, the composition in each of the examples was molded into 4 mm thick testing bars using an injection molding machine with a melting temperature set at 250° C. and mold temperature at 80° C. and the tensile strength (TS), tensile modulus (TM), and elongation (EL) of the test bars were measured in accordance with ISO527-1/2 and the results are tabulated in Table 1.

Similarly, following UL-94, 1.6 mm and 0.8 mm thick test bars were molded. The test bars were then conditioned at 23° C. and 50% relative humidity for 48 hours before the UL-94 flammability rating thereof were measured and tabulated in Table 1.

Finally, the mold deposit issue for each example was examined as follows, First, for each example, the composition was fed into a Sumitomo 100 ton injection molding machine and after the injection molding machine has continuously ran for 1 hour (during which the barrel temperature was set at 260° C. and the mold temperature at 80° C. and 250 pieces of molded plates with a dimension of 0.4×50×50 mm were molded), the surface appearance of the inside of the mold was visually inspected and rated. As reported in Table 1, if no mold deposit was observed, a rating of “−” was given, while if any mold deposit was observed, a rating of “+”, “++”, “+++”, “++++”, or “+++++” was given as the amount of mold deposit goes up.

As shown by in Table 1, when NHFR and MPP were incorporated into PBT as a flame retardant package, obvious mold deposits were observed post injection molding (see, CE3 and CE4). In addition, when urea-resorcinol-formaldehyde coated MPP (UF-C-MPP in CE5) or SiO₂ coated MPP (SiO₂—C-MPP in CE6) were used in place of MPP, such mold deposit problems remained. However, as demonstrated in E1, E2, and E4, when melamine-formaldehyde coated MPP (MF-C-MPP-1 or MF-C-MPP-2) was used in place of MPP, there were no or very little mold deposit could be observed post injection molding. Moreover, as demonstrated by CE4 and E3, by replacing MPP with MF coated MPP, the UL-94 flammability rating of the polymer composition were also improved.

TABLE 1

| | CE1 | CE2 | CE3 | CE4 | CE5 | CE6 | E1 | E2 | E3 | E4 |
|---|---|---|---|---|---|---|---|---|---|---|
| PBT (wt %) | 54.2 | 62.5 | 56.2 | 54.2 | 56.8 | 56.8 | 56 | 55.7 | 54.2 | 54.2 |
| AO (wt %) | 0.3 | 0.34 | 0.31 | 0.3 | 0.31 | 0.31 | 0.31 | 0.31 | 0.3 | 0.3 |
| PTS (wt %) | 0.5 | 0.57 | 0.52 | 0.5 | 0.52 | 0.52 | 0.52 | 0.52 | 0.5 | 0.5 |
| GF (wt %) | 25 | 28.8 | 25.9 | 25 | 26.3 | 26.3 | 25.8 | 25.7 | 25 | 25 |
| NHFR (wt %) | 20 | — | 13.9 | 13.3 | 13.9 | 13.9 | 13.7 | 13.6 | 13.3 | 13.3 |
| MPP (wt %) | — | 7.79 | 3.17 | 6.7 | — | — | — | — | — | — |
| UF-C-MPP (wt %) | — | — | — | — | 2.17 | — | — | — | — | — |
| SiO₂-C-MPP (wt %) | — | — | — | — | — | 2.17 | — | — | — | — |
| MF-C-MPP-1 (wt %) | — | — | — | — | — | — | 3.67 | — | 6.7 | — |
| MF-C-MPP-2 (wt %) | — | — | — | — | — | — | — | 4.17 | — | 6.7 |
| TM (GPa) | 9.9 | n/d | n/d | 10.2 | n/d | n/d | n/d | n/d | 10.2 | n/d |
| TS (MPa) | 98.7 | n/d | n/d | 110.3 | n/d | n/d | n/d | n/d | 107.3 | n/d |
| EL (%) | 2.33 | n/d | n/d | 2.63 | n/d | n/d | n/d | n/d | 2.57 | n/d |
| UL94 (@1.6 mm) | V0 (48.2 s) | n/d | n/d | V0 (23 s) | n/d | n/d | n/d | n/d | V0 (10 s) | n/d |
| UL94 (@0.8 mm) | V1 (71.4 s) | n/d | n/d | V1 (38.4 s) | n/d | n/d | n/d | n/d | V0 (26 s) | n/d |
| Mold deposit* | n/d | + | +++ | +++++ | +++ | +++ | + | — | n/d | — |

*n/d: Not Determined.

What is claimed is:

1. A lame-retardant polymer composition comprising, (a) at least one thermoplastic polymer; (b) 5-35 wt % of at least one phosphorus-based halogen-free flame retardant; (c) 0.1-50 wt % of at least one melamine-formaldehyde coated nitrogen-containing compound; and optionally (d) up to 70 wt % of at least one reinforcing filler, with the total wt % of all components comprised in the flame-retardant polymer composition totaling to 100 wt %, wherein the at least one melamine-formaldehyde coated nitrogen-containing compound comprises a core that is coated with a coating material with the core formed of at least one nitrogen-containing compound and the coating material formed of melamine formaldehyde.

2. The flame-retardant polymer composition of claim 1, wherein the at least one thermoplastic polymer is selected from the group consisting of thermoplastic polyesters, polyamides, polyoxymethylenes, polycarbonates, polyolefins, polyphenylene oxides, polyimides, and combinations of two or more thereof; or, the at least one thermoplastic polymer is selected from the group consisting of thermoplastic polyesters, polyamides, and combinations thereof; or, the at least one thermoplastic polymer is selected from thermoplastic polyesters.

3. The flame-retardant polymer composition of claim 1, wherein the at least one thermoplastic polymer is present in the flame-retardant polymer composition at a level of 20-70 wt % or 30-60 wt %, based on the total weight of the composition.

4. The flame-retardant polymer composition of claim 1, wherein the at least one phosphorus-based halogen-free flame retardant is selected from the group consisting of phosphinates of the formula (I), disphosphinates of the formula (II), and combinations or polymers thereof 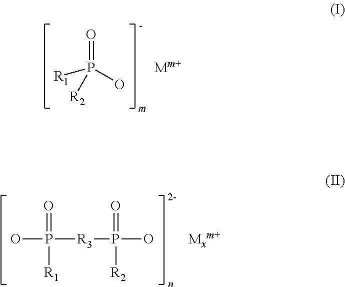
with R₁ and R₂ being identical or different and each of R₁ and R₂ being hydrogen, a linear, branched, or cyclic C₁-C₆ alkyl group, or a C₆-C₁₀ aryl; R₃ being a linear or branched C₁-C₁₀ alkylene group, a C₆-C₁₀ arylene group, a C₆-C₁₂ alkyl-arylene group, or a C₆-C₁₂ aryl-alkylene group; M being selected from the group consisting of calcium ions, aluminum ions, magnesium ions, zinc ions, antimony ions, tin ions, germanium ions, titanium ions, iron ions, zirconium ions, cerium ions, bismuth ions, strontium ions, manganese ions, lithium ions, sodium ions, potassium ions and combinations thereof; and m, n, and x each being a same or different integer of 1-4.

5. The flame-retardant polymer composition of claim 4, wherein the at least one phosphorus-based halogen-free flame retardant is selected from the group consisting of aluminum methylethylphosphinate, aluminum diethylphosphinate, aluminum hypophosphite, and combinations or two or more thereof, or the at least one phosphorus-based halogen-free flame retardant is aluminum methylethylphosphinate or aluminum diethylphosphinate.

6. The flame-retardant polymer composition of claim 1, wherein the at least one phosphorus-based halogen-free flame retardant is present in the flame-retardant polymer composition at a level of 7.5-30 wt %, based on the total weight of the composition.

7. The flame-retardant polymer composition of claim 1, wherein the at least one nitrogen-containing compound is selected from the group consisting of (i) melamine cyanurate, (ii) condensation products of melamine, (iii) reaction products of phosphoric acid with melamine, and (iv) reaction products of phosphoric acid with condensation products of melamine, or the at least one nitrogen-containing compound is melamine polyphosphate.

8. The flame-retardant polymer composition of claim 1, wherein the at least one melamine-formaldehyde coated nitrogen-containing compound comprises about 5-60 wt % or about 10-45 wt % of the coating material, based on the total weight of the melamine-formaldehyde coated nitrogen-containing compound.

9. The flame-retardant polymer composition of claim 1, wherein melamine-formaldehyde coated nitrogen-containing compound is present in the flame-retardant polymer composition at a level of 1-30 wt % or 2-15 wt %, based on the total weight of the composition.

10. The flame-retardant polymer composition of claim 1, wherein the at least one reinforcing filler is selected from fibrous inorganic materials, inorganic fillers, organic fillers, and combinations of two or more thereof, or the at least one reinforcing filler is glass fiber.

11. The flame-retardant polymer composition of claim 1, wherein the at least one reinforcing filler is present in the flame-retardant polymer composition at a level of 5-50 wt %, based on the total weight of the composition.

12. A molded article formed of the flame-retardant polymer composition of claim 1.

13. The molded article of claim 12, which is formed by injection molding.
